(19) United States
(12) Patent Application Publication
(10) Pub. No.: US 2017/0275570 A1
(43) Pub. Date: Sep. 28, 2017

(54) SOLID COMPOSITION FOR THE TREATMENT OF TEXTILES

(71) Applicant: Henkel AG & Co. KGAA, Duesseldorf (DE)

(72) Inventors: Matthias Sunder, Duesseldorf (DE); Frank Meier, Duesseldorf (DE); Sheila Edwards, Duesseldorf (DE); Peter Schmiedel, Duesseldorf (DE)

(73) Assignee: Henkel AG & Co. KGaA, Duesseldorf (DE)

(21) Appl. No.: 15/512,330

(22) PCT Filed: Sep. 18, 2015
(86) PCT No.: PCT/EP2015/071444

§ 371 Date: Mar. 17, 2017

(30) Foreign Application Priority Data
Sep. 19, 2014 (DE) 102014218951.9

(51) Int. Cl. C11D 3/39; C11D 3/08; C11D 3/22; C11D 17/04

(52) U.S. Cl. CPC C11D 3/3917; C11D 17/045; C11D 3/08; C11D 3/222

(57) ABSTRACT

The invention relates to a solid composition for use in the treatment of textiles, containing respectively with respect to the total weight of the solid composition, a respective total amount of 25-65 wt.-% of at least one peroxide compound, 10-20 wt.-% of at least one organic bleaching activator, 5-20 wt.-% alkali metal silicate, 1-15 wt.-% of at least one polysaccharide, 0-5 wt.-% surfactant. Said solid composition is enveloped in a water-soluble material in order to obtain storage-stable single use portions together with liquid surfactant-containing compositions. The claimed solid composition can be used as an additive in conventional textile treatment agents.

### CROSS-REFERENCE TO RELATED APPLICATION

This application is a U.S. National-Stage entry under 35 U.S.C. §371 based on International Application No. PCT/EP2015/071444, filed Sep. 18, 2015, which was published under PCT Article 21(2) and which claims priority to German Application No. 10 2014 218 951.9, filed Sep. 19, 2014, which are all hereby incorporated in their entirety by reference.

### TECHNICAL FIELD

The present disclosure relates to the technical field of textile treatment, in particular for the treatment of textiles, in particular for cleaning textiles and/or washing textiles.

### BACKGROUND

For cleaning textiles, those skilled in the art know about various suitable active substances which, used as additives in washing agents, for example, produce the targeted removal or reduced perception of dirt. For example, those skilled in the art will differentiate for this purpose dirt that is eliminated primarily by surfactants from dirt that can be removed with the help of enzymes or bleaching agents, for example.

The quality of the removal of bleachable soiling, such as colored fruit and vegetable spots, forms a central quality feature of a detergent. During the bleaching, the bleachable dirt should be bleached out and/or removed, on the one hand, but on the other hand, the textile should not be damaged by the bleach.

However, bleaching agents that are stable in storage, when incorporated as an active ingredient into solid washing agents, are not stable in liquid washing agents. Liquid washing agents are increasingly preferred by consumers, and the market share of liquid washing agents is growing. Because of the aforementioned stability problem with bleaching agents in liquid washing agents, a solid bleaching agent composition may be a logical supplement for use in liquid washing agents.

A solid bleaching agent composition that can be used as an additive should contain only a few additional ingredients in addition to the active bleaching compound in order to have conservative use of resources. For packaging of a solid bleaching agent additive in a water-soluble wrapping as a dosing unit, it is advantageous if said bleaching agent additive takes up a small volume. Economization with regard to additional ingredients and a reduction in the volume of the total composition necessarily lead to a high concentration of active bleaching compound. When a liquid textile treatment agent and a solid bleaching agent additive containing a combination of active bleaching compound with polysaccharides (in particular with carboxylated polysaccharides) are stored jointly in separate compartments of a single dose with a water-soluble wrapping, a bad odor develops during storage of the single use dose. The liquid textile treatment agent is also unstable and undergoes a discoloration to brown during storage. The presence of organic bleach activators (in particular bleach activators that form percarboxylic acid) enhances these unwanted effects. Those skilled in the art understand bleach activators to be chemical compounds which increase the bleaching effect in the presence of peroxide compounds.

Despite the stability and odor problems, it should not be necessary to completely omit the addition of polysaccharides as active ingredients in order to supply a bleaching agent additive that will be effective on textile.

The object has therefore been to supply portions as a single-use dose that is stable in storage, so that solid compositions with a high concentration of at least one peroxide compound and at least one organic bleach activator in combination with at least one polysaccharide. Furthermore, the object as contemplated herein was to supply portions as a dosing unit that would be stable in storage for the treatment of textiles and would contain a combination of said solid composition with a liquid textile treatment composition in a water-soluble wrapping. On coming in contact with water, said compositions are released from the portion functioning as a dosage unit.

In addition, the solid composition with a high bleaching agent content should be gentle on the textiles and should improve the washing performance of washing agents, in particular liquid washing agents as an additive within the context of a textile washing.

### BRIEF SUMMARY

Solid compositions for use in treatment of textiles and portions for use in treatment of textiles are provided herein. In an embodiment, a solid composition for use in treatment of textiles is provided. The solid composition includes, each based on the total weight of the solid composition, a total amount of:

from about 25% to about 65% by weight of at least one peroxide compound,
from about 10% to about 20% by weight of at least one organic bleach activator,
from about 5% to about 20% by weight of an alkali metal silicate calculated without the water content,
from about 1% to about 15% by weight of at least one polysaccharide,

from 0 to about 5% by weight surfactant.

In another embodiment a portion for use in treatment of textiles is provided. The portion includes at least two chambers with walls made of a water-soluble material. At least one of the chambers includes a liquid composition including at least one surfactant. At least one additional one of the chambers includes a solid composition. The solid composition includes, each based on the total weight of the second composition, a total amount of:

from about 25% to about 65% by weight of at least one peroxide compound,
from about 10% to about 20% by weight of at least one organic bleach activator,
from about 5% to about 20% by weight of an alkali metal silicate calculated without the water content,
from about 1% to about 15% by weight of at least one polysaccharide,
from 0 to about 5% by weight surfactant.

### DETAILED DESCRIPTION

The following detailed description is merely exemplary in nature and is not intended to limit the cleaning agents and methods for cleaning dishes using the cleaning agents. Furthermore, there is no intention to be bound by any theory presented in the preceding background or the following detailed description.

It has been found that in supplying a single dose, use of alkali silicate compounds in the solid bleaching agent composition containing polysaccharide has a stabilizing effect on the liquid composition in said portion. The development of a bad odor is prevented. An increase in washing performance is achieved.

A first subject matter as contemplated herein is therefore a solid composition for use in the treatment of textiles, containing a total amount of the following, each based on the total weight of the solid composition:
from about 25% to about 65% by weight of at least one peroxide compound,
from about 10% to about 20% by weight of at least one organic bleach activator,
from about 5% to about 20% by weight alkali metal silicate,
from about 1% to about 15% by weight of at least one polysaccharide,
from 0% to about 5% by weight surfactant.

The solid composition may also contain additional optical ingredients beyond the ingredients necessarily present. Said total amounts are selected from the predetermined quantitative weight ranges, such that, together with the amounts of optional ingredients, the result is 100% by weight for said solid composition, based on its total weight.

A composition is solid as contemplated herein if it is present in a solid aggregate state at 25° C. and 1013 mbar.

As contemplated herein, a composition is liquid when it is present in a liquid aggregate state at 25° C. and 1013 mbar.

A chemical compound is an organic compound if the molecule of the chemical compound contains at least one covalent bond between carbon and hydrogen. This definition applies, mutatis mutandis, to organic bleach activators as chemical compounds.

As the converse of the definition of an organic compound, a chemical compound is an inorganic compound if the molecule of the chemical compound does not contain a covalent bond between carbon and hydrogen. This definition applies, mutatis mutandis, to inorganic peroxide compounds as the chemical compound among other things.

A peroxide compound is a chemical compound which contains as a structural fragment the peroxo atomic group —O—O—.

Unless explicitly stated to the contrary, the average molecular weights specified for polymeric ingredients within the context of this patent application are always weight-average molecular weights M_{w} which can basically be determined by means of gel permeation chromatography with the help of an RI detector, wherein the measurement is expediently made against an external standard.

It has also proven to be preferred if the solid composition as contemplated herein is formed from several solid particles. Such an embodiment of the solid composition is preferably in the form of a powder or granules. Said solid particles in turn preferably have a particle diameter X_{50.3} (volume average) of from about 100 to about 1500 μm. These particle sizes can be determined by screening or by using a Camsizer particle size analyzer from the Retsch Co.

The solid composition as contemplated herein necessarily contains a defined amount of peroxide compound. It has been found to be preferred if the solid composition as contemplated herein contains, based on the total weight of the composition, peroxide compounds in a total amount of from about 30 to about 50% by weight, in particular from about 33 to about 45% by weight.

It is preferred as contemplated herein if the peroxide compound is selected from at least one inorganic peroxide compound.

In particular, percarbonate compounds, perborate compounds, peroxodisulfate compounds, hydrogen peroxide, addition compounds of hydrogen peroxide onto inorganic compounds, organic peroxy acids or mixtures of at least two of these compounds can be listed as suitable peroxide compounds. It is especially preferred as contemplated herein if the peroxide compound is selected from sodium percarbonate, sodium perborate, sodium peroxodisulfate or mixture thereof. Sodium percarbonate is a most especially preferred peroxide compound. Sodium percarbonate is an addition compound of hydrogen peroxide onto sodium carbonate with the formula yNa₂CO₃.xH₂O₂, where x denotes the amount of hydrogen peroxide per y mol Na₂CO₃. The peroxide compound Na₂CO₃.1.5H₂O₂ with the CAS number 15630-89-4 is the most preferred.

The peroxide compound used as contemplated herein preferably has as contemplated herein an active oxygen content between about 9.0% and about 15.0%, in particular from about 10.0% to about 14.0% (each measured by titration with the potassium permanganate).

For solving the problem on which the disclosure is based, it has been found to be preferable if the peroxide compound is in the form of particles, in particular in the form of a powder or granules. It is in turn preferred if the particles containing the peroxide compound (for example, the powder or granules) have a bulk density of from about 0.70 to about 1.30 kg/dm³, especially preferably a bulk density of from about 0.85 to about 1.20 kg/dm³ (each measured according to ISO 697).

In addition, such peroxide compounds whose particles have an average particle size (volume average) X_{50.3} of from about 0.40 to about 0.95 mm, in particular of from about 0.50 to about 0.90 mm are preferably suitable (for example, measured by screen analysis or by using a Camsizer particle size analyzer from the Retsch Co.).

A solid peroxide compound, in particular sodium percarbonate, may be provided with a coating for additional protection against decomposition at the surface. This coating should protect the percarbonate from decomposition. Suitable coating agents include preferably water-soluble passivating agents such as, for example, sodium hydrogen carbonate, sodium carbonate, sodium sulfate or metaborate compounds. It may be preferable as contemplated herein if the solid peroxide compound, in particular sodium percarbonate, is coated at least with sodium sulfate at the surface. It is preferable as contemplated herein if the solid peroxide compound has an average particle size X_{50.3} of from about 0.40 to about 0.95 mm, in particular of from about 0.40 to about 0.90 mm (e.g., measured by screen analysis or by using a Camsizer particle size analyzer from the Retsch Co.) and if the particles are coated with sodium sulfate.

To additionally increase the storage stability of the composition as contemplated herein, the peroxide compound used may be coated with a phlegmatizing agent, in particular with a metaborate compound (the composition as contemplated herein advantageously contains from about 50% to about 100% by weight, based on the peroxide compound content, metaborate-coated peroxide compound) with phlegmatization (i.e., reduction in or prevention of possible heat developing due to exothermic decomposition of the solid peroxide compound). However, the phlegmatizing coating of the solid peroxide compound is not absolutely necessary.

The composition as contemplated herein necessarily contains an organic bleach activator in a total amount of from about 10% to about 20% by weight, preferably from about 11% to about 18% by weight, especially preferably from about 12 to about 16% by weight, again preferably from about 10% to about 15% by weight, most especially preferably from about 11% to about 14% by weight.

The organic bleach activators that are used are preferably compounds that yield, under perhydrolysis conditions, percarboxylic acids (in particular aliphatic peroxycarboxylic acids preferably with from 1 to 10 carbon atoms, in particular from 2 to 4 carbon atoms) and/or optionally substituted perbenzoic acid. The aforementioned total amounts are also applicable, mutatis mutandis, to these special organic bleach activators.

Compositions containing organic bleach activators from at least one compound from the group of compounds that form aliphatic peroxycarboxylic acids under perhydrolysis conditions are especially preferred as contemplated herein. It is especially preferable if the organic bleach activator is selected from at least one compound of the poly-N-acylated organic amines. The total amounts mentioned above also apply, mutatis mutandis, to these special organic bleach activators.

Perhydrolysis is a reaction with which those skilled in the art are familiar, in which an anion ⁻O—O—H binds covalently to a reactant R—X in a protic solvent (e.g., water), while retaining the compound R—O—O—H by nucleophilic substitution and causing a departing group X to be split off with lysis of the chemical bond between R and X.

Of all the bleach activators known to those skilled in the art from the prior art, polyacylated alkylenediamines, in particular tetraacetylethylenediamine (TAED), acylated triazine derivatives, in particular 1,5-diacetyl-2,4-dioxohexahydro-1,3,5-triazine (DADHT), acylated glycolurils, in particular, tetraacetylglycoluril (TAGU), N-acylimides, in particular N-nonanoylsuccinimide (NOSI), acylated phenol sulfonates, in particular n-nonanoyl or isononanoyloxybenzene sulfonate (n- and/or iso-NOBS) are especially preferably used. The total amounts listed above also apply, mutatis mutandis, to these special organic bleach activators.

The composition as contemplated herein most especially preferably contains as a bleaching block:
from about 25% to about 65% by weight of at least one inorganic peroxide compound, in particular sodium percarbonate, and
from about 10% to about 20% by weight of at least one organic bleach activator, from at least one compound from the group of compounds that form aliphatic peroxycarboxylic acids under perhydrolysis conditions, in particular at least one poly-N-acylated organic amine.

The composition as contemplated herein of the first subject matter as contemplated herein necessarily contains a defined amount of alkali metal silicate. Suitable alkali metal silicates include sodium silicate and/or potassium silicate in particular. Sodium silicate is especially preferred. Most especially preferred sodium silicates include sodium metasilicate or water glass; water glass is in turn preferably used in the solid composition as contemplated herein.

The quantitative amount of the alkali metal silicate is calculated without including the amount of water (hydrate) optionally contained in the alkali metal silicate.

It is preferred as contemplated herein if the alkaline metal silicates that are contained in the composition are present in the form of particles, in particular as granules. In addition, alkali metal silicates whose particles have an average particle size (volume average) X_{50.3} of from about 0.20 to about 1.00 mm, in particular from about 0.30 to about 0.90 mm, in particular from about 0.50 to about 0.80 mm (for example, measured by screen analysis or by using a Camsizer particle size analyzer from the Retsch Co.), are also preferably suitable.

Regardless of or in combination with these, alkali metal silicates of the formula (SiO2)n(Na2O)m(K2O)p are especially preferred as contemplated herein, where n stands for a positive rational number and m and p, independently of one another, stand for a positive rational number, with the provisions that at least one of the parameters m or p is different from 0 and the ratio between n and the sum of m and p is between about 1:4 and about 4:1, in particular in the ratio range from about 2:1 to about 4:1.

In a particularly preferred embodiment as contemplated herein, the solid composition as contemplated herein contains as the alkali metal silicate a silicate of the formula (SiO₂)ₙ(Na₂O)ₘ, where n stands for a positive number and m stands for a positive rational number with the provision that the ratio between n and m is between about 1:4 and about 4:1, in particular in the ratio range from about 2:1 to about 4:1. The following embodiments (A) and/or (B) are therefore considered to be especially preferred:

(A) Solid composition for use in treatment of textiles each containing, based on the total weight of the solid composition, a total amount of
from about 25% to about 65% by weight of at least one peroxide compound, in particular sodium percarbonate,
from about 10% to about 20% by weight of at least one organic bleach activator,
from about 5% to about 20% by weight silicate of the formula (SiO2)ₙ(Na2O)ₘ, where n stands for a positive rational number and m stands for a positive rational number, with the provision that the ratio between n and m is between about 1:4 and about 4:1, in particular between about 2:1 and about 4:1,
from about 1% to about 15% by weight of at least one polysaccharide,
from 0% to about 5% by weight surfactant.

(B) Solid composition for use in treatment of textiles, each containing, based on the total weight of the solid composition, a total amount of
from about 25% to about 65% by weight of at least one peroxide compound, in particular sodium percarbonate,
from about 10% to about 20% by weight of at least one organic bleach activator,
from about 5% to about 20% by weight granules of silicate with the formula (SiO₂)ₙ(Na₂O)ₘ with an average particle size (volume average) X_{50.3} of from about 0.20 to about 1.00 mm, in particular of from about 0.30 to about 0.90 mm, in particular from about 0.50 to about 0.80 mm, where n stands for a positive rational number and m stands for a positive rational number with the provision that the ratio between n and m is between about 1:4 and about 4:1, in particular between about 2:1 and about 4:1,
from about 1% to about 15% by weight of at least one polysaccharide,
from 0% to about 5% by weight surfactant.

Furthermore, it has been found to be preferred as contemplated herein if the solid compositions as contemplated herein have an alkalinity, expressed as a pH of from about 10.0 to about 11.5, in particular a pH of from about 10.0 to about 10.5, each measured on a 1% by weight solution of the composition in water at 20° C.

As additional ingredients, the compositions as contemplated herein necessarily contain at least a defined total amount of polysaccharide.

A polysaccharide is understood as contemplated herein to include saccharides containing at least 10 sugar structural units glycosidically linked together.

Within the context of a preferred embodiment, the polysaccharide is present in the form of particles (preferably as a powder or granules, especially preferably as granules). It is in turn preferred if these particles have an average particle size (volume average) X_{50.3} of from about 200 to about 1600 μm, in particular of from about 300 to about 1400 μm, in particular of from about 400 to about 1200 μm, most especially preferably of from about 600 to about 1100 μm (for example, measured by screen analysis or by using a Camsizer particle size analyzer, Retsch Co.).

Preferred polysaccharides include celluloses and derivatives thereof, starch and derivatives thereof and mixtures thereof. As the polysaccharide, the solid composition as contemplated herein preferably contains methyl cellulose, ethyl cellulose, hydroxyethyl cellulose, hydroxypropyl cellulose, methyl hydroxyethyl cellulose, methyl carboxymethyl cellulose, ethyl hydroxyethyl cellulose, carboxymethyl cellulose (CMC), an ether sulfonic acid salt of starch, an ether sulfonic acid salt of cellulose, an acidic sulfuric acid ester salt of cellulose, an acidic sulfuric acid ester salt of starch or a mixture of at least two of these polysaccharides.

The effect as contemplated herein is especially pronounced when at least one polysaccharide having at least one anionic group in the solid composition as contemplated herein is included as the polysaccharide. Groups that bound covalently to the polysaccharide and are capable of forming an anion with formal release of an H⁺ ion in protic solvents function as ionic groups; such anions include in particular carboxyl groups (—COOH), sulfonic acid groups (—SO₃H), sulfate groups (—O—SO₃H), phosphonic acid group (—PO₃H). Use of at least one polysaccharide containing at least one carboxyl group, especially preferably at least one carboxyalkyl-derivatized polysaccharide is preferred. A carboxyl group is understood as contemplated herein to include both the acid form —COOH as well as the deprotonated salt form (carboxylate group) with a corresponding cation as the counterion. Corresponding cations that are suitable include in particular monovalent ions such as sodium ions, potassium ions, ammonium ions. This is also true, mutatis mutandis, for carboxyalkyl-derivatized polysaccharide.

In a preferred embodiment, at least one anionic polysaccharide selected from anionic cellulose, anionic starch or mixtures thereof is present as the polysaccharide. It is in turn preferred if the polysaccharide is selected from carboxyalkyl-derivatized cellulose, carboxyalkyl-derivatized starch or mixtures thereof. Carboxyalkyl-derivatized cellulose is most especially preferred as contemplated herein.

The particularly preferred carboxyalkyl-derivatized polysaccharides are preferably reacted as contemplated herein by reacting polysaccharides (in particular cellulose or starch, especially preferably cellulose) with haloalkane carboxylic acids (in particular 2-chloroacetic acid) in the presence of an alkalizing agent (in particular sodium hydroxide solution).

Carboxymethyl cellulose, in particular sodium carboxymethyl cellulose is most especially preferably present as the polysaccharide in the compositions as contemplated herein.

Within the scope of the embodiment of the compositions containing carboxymethyl cellulose as contemplated herein, it is again preferred if the carboxymethyl cellulose has been synthesized by reacting cellulose with 2-chloroacetic acid or 2-bromoacetic acid or 2-iodoacetic acid (in particular 2-chloroacetic acid) in the presence of an alkalizing agent, in particular sodium hydroxide.

It is preferred as contemplated herein if the polysaccharides are present in the solid agent as contemplated herein in a particle together with at least one salt containing halide ions (preferably at least one salt containing chloride ions, bromide ions, iodide ions or mixture thereof, especially preferably chloride ions, most especially preferably sodium chloride). Within the scope of this preferred embodiment, the solid composition as contemplated herein contains from about 1% to about 15% by weight polysaccharide in addition to the other obligatory parameters, wherein the polysaccharide (in particular a polysaccharide with at least one anionic group, especially preferably a polysaccharide containing at least one carboxyl group, especially preferably carboxyalkyl-derivatized polysaccharide, most especially preferably carboxymethyl cellulose) is present jointly in a particle with a salt that contains halide ions (in particular according to the preferred embodiments above). It is again preferable if these particles have an average particle (volume average) X_{50.3} of from about 200 to about 1600 μm, in particular of from about 300 to about 1400 μm, in particular of from about 400 to about 1200 μm, most especially preferably of from about 600 to about 1100 μm (for example, measured by screen analysis or by using a Camsizer particle size analyzer, Retsch Co.).

The preferred total amount of polysaccharide, in particular the preferred polysaccharide (see above) (especially preferably of carboxymethyl cellulose) is from about 1.5 to about 12.0% by weight, in particular from about 2.0 to about 10.0% by weight, most especially preferably from about 2.5 to about 9.5% by weight, each based on the weight of said composition.

It is again preferred to combine the alkali silicates that are preferred for use with the polysaccharides that are preferably suitable according to the present disclosure. The following embodiments (C) through (P) are considered especially preferred in particular:

(C) Solid composition for use in treatment of textiles, containing, based on the total weight of the solid composition, a total amount of
from about 25% to about 65% by weight of at least one peroxide compound, in particular sodium percarbonate,
from about 10% to about 20% by weight of at least one organic bleach activator,
from about 5% to about 20% by weight granules of silicate with the formula (SiO₂)ₙ(Na₂O)ₘ, where n stands for a positive rational number and m stands for a positive rational number with the provision that the ratio between n and m is between about 1:4 and about 4:1, in particular between about 2:1 and about 4:1,
from about 1% to about 15% by weight of at least one polysaccharide with an anionic group,
about 0% to about 5% by weight surfactant.

(D) Solid composition for use in treatment of textiles, each containing, based on the total weight of the solid composition, a total amount of
from about 25% to about 65% by weight of at least one peroxide compound, in particular sodium percarbonate,
from about 10% to about 20% by weight of at least one organic bleach activator,
from about 5% to about 20% by weight granules of silicate with the formula (SiO₂)ₙ(Na₂O)ₘ, where n stands for a positive rational number and m stands for a positive rational number with the provision that the ratio between n and m is between about 1:4 and about 4:1, in particular between about 2:1 and about 4:1,
from about 1% to about 15% by weight of at least one carboxyalkyl-derivatized polysaccharide,
from 0% to about 5% by weight surfactant.

(E) Solid composition for use in treatment of textiles, each containing, based on the total weight of the solid composition, a total amount of
from about 25% to about 65% by weight of at least one peroxide compound, in particular sodium percarbonate,
from about 10% to about 20% by weight of at least one organic bleach activator,
from about 5% to about 20% by weight granules of silicate with the formula (SiO₂)ₙ(Na₂O)ₘ, where n stands for a positive rational number and m stands for a positive rational number with the provision that the ratio between n and m is between about 1:4 and about 4:1, in particular between about 2:1 and about 4:1,
from about 1% to about 15% by weight carboxymethyl cellulose,
from 0% to about 5% by weight surfactant.

(F) Solid composition for use in treatment of textiles, each containing, based on the total weight of the solid composition, a total amount of
from about 25% to about 65% by weight of at least one peroxide compound, in particular sodium percarbonate,
from about 10% to about 20% by weight of at least one organic bleach activator,
from about 5% to about 20% by weight granules of silicate with the formula (SiO₂)ₙ(Na₂O)ₘ, where n stands for a positive rational number and m stands for a positive rational number with the provision that the ratio between n and m is between about 1:4 and about 4:1, in particular between about 2:1 and about 4:1,
from about 1% to about 15% by weight of at least one polysaccharide, wherein polysaccharides are present in the solid composition as contemplated herein in a particle jointly with at least one salt containing halide ions (in particular sodium chloride),
from 0% to about 5% by weight surfactant.

(G) Solid composition for use in treatment of textiles, each containing, based on the total weight of the solid composition, a total amount of
from about 25% to about 65% by weight of at least one peroxide compound, in particular sodium percarbonate,
from about 10% to about 20% by weight of at least one organic bleach activator,
from about 5% to about 20% by weight granules of silicate with the formula (SiO₂)ₙ(Na₂O)ₘ, where n stands for a positive rational number and m stands for a positive rational number with the provision that the ratio between n and m is between about 1:4 and about 4:1, in particular between about 2:1 and about 4:1,
from about 1% to about 15% by weight of at least one polysaccharide with an anionic group wherein anionically-modified polysaccharides are present in the solid composition as contemplated herein in a particle jointly with at least one salt containing halide ions (in particular sodium chloride),
from 0% to about 5% by weight surfactant.

(H) Solid composition for use in treatment of textiles, each containing, based on the total weight of the solid composition, a total amount of
from about 25% to about 65% by weight of at least one peroxide compound, in particular sodium percarbonate,
from about 10% to about 20% by weight of at least one organic bleach activator,
from about 5% to about 20% by weight granules of silicate with the formula (SiO₂)ₙ(Na₂O)ₘ, where n stands for a positive rational number and m stands for a positive rational number with the provision that the ratio between n and m is between about 1:4 and about 4:1, in particular between about 2:1 and about 4:1,
from about 1% to about 15% by weight of at least one carboxyalkyl-derivatized polysaccharide, wherein carboxyalkyl-derivatized polysaccharides are present in the solid composition as contemplated herein in a particle jointly with at least one salt containing halide ions (in particular sodium chloride),
from 0% to about 5% by weight surfactant.

(I) Solid composition for use in treatment of textiles, each containing, based on the total weight of the solid composition, a total amount of
from about 25% to about 65% by weight of at least one peroxide compound, in particular sodium percarbonate,
from about 10% to about 20% by weight of at least one organic bleach activator,
from about 5% to about 20% by weight granules of silicate with the formula (SiO₂)ₙ(Na₂O)ₘ, where n stands for a positive rational number and m stands for a positive rational number with the provision that the ratio between n and m is between about 1:4 and about 4:1, in particular between about 2:1 and about 4:1,
from about 1% to about 15% by weight carboxymethyl cellulose, wherein carboxymethyl cellulose is present in the solid composition as contemplated herein in a particle jointly with at least one salt containing halide ions (in particular sodium chloride),
from 0% to about 5% by weight surfactant.

(J) Solid composition for use in treatment of textiles, each containing, based on the total weight of the solid composition, a total amount of
from about 25% to about 65% by weight of at least one peroxide compound, in particular sodium percarbonate,
from about 10% to about 20% by weight of at least one organic bleach activator,
from about 5% to about 20% by weight granules of silicate with the formula (SiO₂)ₙ(Na₂O)ₘ, with an average particle size (volume average) X_{50.3} of from about 0.20 to about 1.00 mm, in particular of from about 0.30 to about 0.90 mm, in particular of from about 0.50 to about 0.80 mm, where n stands for a positive rational number and m stands for a positive rational number with the provision that the ratio between n and m is between about 1:4 and about 4:1, in particular between about 2:1 and about 4:1,
from about 1% to about 15% by weight of at least one polysaccharide with an anionic group,
from 0% to about 5% by weight surfactant.

(K) Solid composition for use in treatment of textiles, each containing, based on the total weight of the solid composition, a total amount of
from about 25% to about 65% by weight of at least one peroxide compound, in particular sodium percarbonate,
from about 10% to about 20% by weight of at least one organic bleach activator,
from about 5% to about 20% by weight granules of silicate with the formula (SiO₂)ₙ(Na₂O)ₘ, with an average particle size (volume average) X_{50.3} of from about 0.20 to about 1.00 mm, in particular of from about 0.30 to 0.90 mm, in particular of from about 0.50 to about 0.80 mm, where n stands for a positive rational number and m stands for a positive rational number with the provision that the ratio between n and m is between about 1:4 and about 4:1, in particular between about 2:1 and about 4:1,
from about 1% to about 15% by weight of at least one carboxyalkyl-derivatized polysaccharide,
from 0% to about 5% by weight surfactant.

(L) Solid composition for use in treatment of textiles, each containing, based on the total weight of the solid composition, a total amount of
from about 25% to about 65% by weight of at least one peroxide compound, in particular sodium percarbonate,
from about 10% to about 20% by weight of at least one organic bleach activator,
from about 5% to about 20% by weight granules of silicate with the formula (SiO₂)ₙ(Na₂O)ₘ, with an average particle size (volume average) X_{50.3} of from about 0.20 to about 1.00 mm, in particular of from about 0.30 to about 0.90 mm, in particular of from about 0.50 to about 0.80 mm, where n stands for a positive rational number and m stands for a positive rational number with the provision that the ratio between n and m is between about 1:4 and about 4:1, in particular between about 2:1 and about 4:1,
from about 1% to about 15% by weight carboxymethyl cellulose,
from 0% to about 5% by weight surfactant.

(M) Solid composition for use in treatment of textiles, each containing, based on the total weight of the solid composition, a total amount of
from about 25% to about 65% by weight of at least one peroxide compound, in particular sodium percarbonate,
from about 10% to about 20% by weight of at least one organic bleach activator,
from about 5% to about 20% by weight granules of silicate with the formula (SiO₂)ₙ(Na₂O)ₘ, with an average particle size (volume average) X_{50.3} of from about 0.20 to about 1.00 mm, in particular of from about 0.30 to v0.90 mm, in particular of from about 0.50 to about 0.80 mm, where n stands for a positive rational number and m stands for a positive rational number with the provision that the ratio between n and m is between about 1:4 and about 4:1, in particular between about 2:1 and about 4:1,
from about 1% to about 15% by weight of at least one polysaccharide wherein polysaccharides are present in the solid composition as contemplated herein in a particle jointly with at least one salt containing halide ions (in particular sodium chloride),
from 0% to about 5% by weight surfactant.

(N) Solid composition for use in treatment of textiles, each containing, based on the total weight of the solid composition, a total amount of
from about 25% to about 65% by weight of at least one peroxide compound, in particular sodium percarbonate,
from about 10% to about 20% by weight of at least one organic bleach activator,
from about 5% to about 20% by weight granules of silicate with the formula (SiO₂)ₙ(Na₂O)ₘ, with an average particle size (volume average) X_{50.3} of from about 0.20 to about 1.00 mm, in particular of from about 0.30 to about 0.90 mm, in particular of from about 0.50 to about 0.80 mm, where n stands for a positive rational number and m stands for a positive rational number with the provision that the ratio between n and m is between about 1:4 and about 4:1, in particular between about 2:1 and about 4:1,
from about 1% to about 15% by weight of at least one polysaccharide with an anionic group, wherein these polysaccharides are present in the solid composition as contemplated herein in a particle jointly with at least one salt containing halide ions (in particular sodium chloride),
from 0% to about 5% by weight surfactant.

(O) Solid composition for use in treatment of textiles, each containing, based on the total weight of the solid composition, a total amount of
from about 25% to about 65% by weight of at least one peroxide compound, in particular sodium percarbonate,
from about 10% to about 20% by weight of at least one organic bleach activator,
from about 5% to about 20% by weight granules of silicate with the formula (SiO₂)ₙ(Na₂O)ₘ, with an average particle size (volume average) X_{50.3} of from about 0.20 to about 1.00 mm, in particular of from about 0.30 to about 0.90 mm, in particular of from about 0.50 to about 0.80 mm, where n stands for a positive rational number and m stands for a positive rational number with the provision that the ratio between n and m is between about 1:4 and about 4:1, in particular between about 2:1 and about 4:1,
from about 1% to about 15% by weight of at least one carboxyalkyl-derivatized polysaccharide, wherein carboxyalkyl-derivatized polysaccharides are present in the solid composition as contemplated herein in a particle jointly with at least one salt containing halide ions (in particular sodium chloride),
from 0% to about 5% by weight surfactant.

(P) Solid composition for use in treatment of textiles, each containing, based on the total weight of the solid composition, a total amount of
from about 25% to about 65% by weight of at least one peroxide compound, in particular sodium percarbonate,
from about 10% to about 20% by weight of at least one organic bleach activator,
from about 5% to about 20% by weight granules of silicate with the formula (SiO₂)ₙ(Na₂O)ₘ, with an average particle size (volume average) X_{50.3} of from about 0.20 to about 1.00 mm, in particular of from about 0.30 to about 0.90 mm, in particular of from about 0.50 to about 0.80 mm, where n stands for a positive rational number and m stands for a positive rational number with the provision that the ratio between n and m is between about 1:4 and about 4:1, in particular between about 2:1 and about 4:1,
from about 1% to about 15% by weight carboxymethyl cellulose, wherein carboxymethyl cellulose is present in the solid composition as contemplated herein in a particle jointly with at least one salt containing halide ions (in particular sodium chloride),
from 0% to about 5% by weight surfactant.

The embodiments preferred as contemplated herein (in particular with respect to the type of ingredients, the amounts of ingredients, the combination of ingredients (in particular the preferred bleaching block (see above)), the quantity ratios of the ingredients, the morphology of the ingredients (e.g., particles, granules, particle sizes), the production of the ingredients (in particular the production of said polysaccharide) are also considered to be preferred as contemplated herein, mutatis mutandis, for the embodiments (A) through (P).

In another preferred embodiment, the composition as contemplated herein additionally contains at least one soil-release active ingredient. Soil-release substances are often referred to as “soil-release” active ingredients or as “soil repellents” because of their ability to provide a soil repellant finish to the treated surface, for example, of the fibers. Copolyesters containing dicarboxylic acid units, alkylene glycol units and polyalkylene glycol units are especially effective soil-repellant active ingredients because of their chemical similarity to polyester fibers, but these may also manifest the desired effect on fabrics made of other materials. Soil-repellant polyesters of the aforementioned type as well as their use in washing agent have been known for a long time.

Thus, for example, polymers of ethylene terephthalate and polyethylene oxide terephthalate, in which the polyethylene glycol units have molecular weights of from about 750 to about 5000 and the molar ratio of ethylene terephthalate to polyethylene oxide terephthalate is from about 50:50 to about 90:10 and the use thereof in washing agents are described in the German patent specification DE 28 57 292. Polymers with a molecular weight of 15,000 to 50,000 from ethylene terephthalate and polyethylene oxide terephthalate, wherein the polyethylene glycol units have molecular weights of 1000 to 10,000 and the molar ratio of ethylene terephthalate to polyethylene oxide terephthalate is 2:1 to 6:1 may be used in washing agents according to the unexamined German patent application DE 33 24 258. European Patent EP 066 944 relates to textile treatment agents containing a copolyester of ethylene glycol, polyethylene glycol, aromatic dicarboxylic acid and sulfonated aromatic dicarboxylic acid in certain molar ratios. European Patent EP 185 427 discloses polyesters having methyl or ethyl group end caps with ethylene and/or propylene terephthalate and polyethylene oxide terephthalate units as well as washing agents containing such soil-release polymers. European Patent EP 241 984 relates to a polyester which also contains, in addition to ethylene oxide groups and terephthalic acid units, substituted ethylene units as well as glycerol units. European Patent EP 241 985 discloses polyesters which also contain, in addition to ethylene oxide groups and terephthalic acid units, 1,2-propylene, 1,2-butylene and/or 3-methoxy-1,2-propylene groups as well as glycerol units and with C₁ to C₄ alkyl group end group capping. European Patent EP 253 567 relates to soil-release polymers having a molecular weight of 900 to 9000 from ethylene terephthalate and polyethylene oxide terephthalate wherein the polyethylene glycol units have molecular weights of 300 to 3000 and the molar ratio of ethylene terephthalate to polyethylene oxide terephthalate is 0.6 to 0.95. European Patent Application EP 272 033 discloses polyesters with polypropylene terephthalate and polyoxyethylene terephthalate units with proportional end group capping by C₁₋₄ alkyl or acyl radicals. European Patent EP 274 907 describes sulfoethyl end group-capped terephthalate-containing soil-release polyesters. European patent application EP 357 280 describes the production of soil-release polyesters with terephthalate, alkylene glycol and poly-C₂₋₄-glycol units produced by sulfonation of unsaturated end groups.

In a preferred embodiment as contemplated herein, the composition as contemplated herein contains at least one soil-release polyester containing the structural units I through III or I through IV:

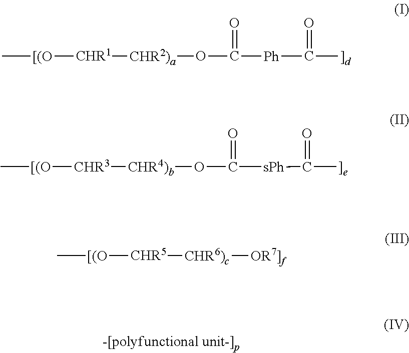

in which
a, b and c, independently of one another, each stand for a number from 1 to about 200,
d, e and f, independently of one another, each stand for a number from 1 to 50,
g stands for a number from 0 to 5,
Ph stands for a 1,4-phenylene radical,
sPh stands for a 1,3-phenylene radical substituted in position 5 with an —SO₃M group,
M stands for Li, Na, K, Mg/2, Ca/2, Al/3, ammonium, mono-, di-, tri- or tetraalkylammonium, wherein the alkyl radicals of the ammonium ions are C₁-C₂₂ alkyl or C₂-C₁₀ hydroxyalkyl radicals or any mixture thereof,
R¹, R², R³, R⁴, R⁵ and R⁶, independently of one another, each stand for hydrogen or a C₁-C₁₈ n- or isoalkyl group,
R⁷ stands for a linear or branches C₁-C₃₀ alkyl group or a linear or branched C₂-C₃₀ alkenyl group, for a cycloalkyl group with 5 to 9 carbon atoms, for a C₆-C₃₀ aryl group or for a C₆-C₃₀ arylalkyl group and “polyfunctional unit” stands for a unit with 3 to 6 functional groups capable of entering into an esterification reaction.

These preferably include polyesters, in which R¹, R², R³, R⁴, R⁵ and R⁶, independently of one another, each denotes hydrogen or methyl, R⁷ stands for methyl, a, b and c, independently of one another, each stand for a number from 1 to about 200, in particular 1 to 20, especially preferably 1 to 5, extremely preferably a and b=1 and c may be a number from 2 to 10, d is a number between 1 and 25, in particular between 1 and 10, especially preferably between 1 and 5, e is a number between 1 and 30, in particular between 2 and 15, especially preferably between 3 and 10 and f is a number between about 0.05 and about 15, in particular between about 0.1 and about 10 and especially preferably between about 0.25 and about 3. Such polyesters can be obtained, for example, by polycondensation of terephthalic acid dialkyl esters, 5-sulfoisophthalic acid dialkyl esters, alkylene glycols, optionally polyalkylene glycols (in which a, b, and/or c>1) and polyalkylene glycols (corresponding to unit III) end-capped at one end. It should be pointed out that a polymeric backbone is present for numbers a, b, c>1 and thus the coefficients may assume any value within the given interval as the average value. This value reflects the number-average molecular weight. An ester of terephthalic acid with one or more difunctional aliphatic alcohols may be considered as unit (I) but ethylene glycol (R¹ and R² each stand for H) and/or 1,2-propylene glycol (R¹=H and R²=—CH₃ or vice versa) and/or shorter-chain polyethylene glycols and/or polyethylene glycol-co-propylene glycol with number-average molecular weights of from about 100 to about 2000 g/mol are preferably used here. For example, 1 to 50 units (I) may be present per polymer chain in the structures. Examples of unit (II) that may be used include an ester of 5-sulfoisophthalic acid with one or more difunctional aliphatic alcohols, but those listed above are preferred for use here. For example, 1 to 50 units (II) may be present in the structures. The nonionic polyalkylene glycol monoalkyl ethers according to unit (III) that are capped at one end preferably include polyethylene glycol-co-propylene glycol monomethyl ethers with an average molecular weight of from about 100 to about 2000 g/mol and polyethylene glycol monomethyl ethers of general formula CH₃—O—(C₂H₁O)ₙ—H, where n=1 to 99, in particular 1 to 20 and especially preferably 2 to 10. By using such capped ethers capped at one end, the theoretical maximum average molecular weight to be achieved at complete conversion of a polyester structure is predetermined, so the preferred use amount of structural unit (III) is that which is necessary to achieve the average molecular weights given below. In addition to linear polyesters, which result from the structural units (I), (II) and (III), use of crosslinked or branched polyester structures is also as contemplated herein. This is expressed by the presence of a polyfunctional structure unit (IV), which has a crosslinking effect and has at least three up to at most six functional groups capable of entering into an esterification reaction. Functional groups that can be mentioned here include, for example, acid, alcohol, ester, anhydride or epoxy groups. Various functionalities are also possible in one molecule. Examples of this may include citric acid, malic acid, tartaric acid and gallic acid, especially preferably 2,2-dihydroxymethylpropionic acid. In addition, polyvalent alcohols such as pentaerythritol, glycerol, sorbitol and/or trimethylolpropane may be used. These may also be polyvalent aliphatic or aromatic carboxylic acids such as benzene-1,2,3-tricarboxylic acid (hemimellitic acid), benzene-1,2,4-tricarboxylic acid (trimellitic acid) or benzene-1,3,5-tricarboxylic acid (trimesic acid). The amount by weight of crosslinking monomers based on the total mass of the polyester may be up to about 10% by weight, in particular up to about 5% by weight and especially preferably up to about 3% by weight. The polyesters containing structural units (I), (II) and (III) and optionally (IV) have in general number-average molecular weights in the range of from about 700 to about 50,000 g/mol, wherein the number-average molecular weight can be determined by means of size exclusion chromatography in aqueous solution using calibration with the help of polyacrylic acid sodium salt standards having a narrow distribution. The number-average molecular weights are preferably in the range of from about 800 to about 25,000 g/mol, in particular from about 1000 to about 15,000 g/mol, especially preferably from about 1200 to about 12,000 g/mol. As contemplated herein, solid polyesters having softening points above about 40° C. are preferably used as components of the particle of the second type. They preferably have a softening point between about 50 and about 200° C., especially preferably between about 80° C. and about 150° C. and extraordinarily preferably between about 100° C. and about 120° C. The polyesters can be synthesized by known methods, for example, by first heating the aforementioned components at normal pressure with the addition of a catalyst and then building up to the required molar weights in vacuo by distilling off excess amounts of the starting glycols above the stoichiometric amount. The known transesterification catalysts and condensation catalysts such as titanium tetraisopropylate, dibutyltin oxide, alkali or alkaline earth metal alcoholates or antimony trioxide/calcium acetate are suitable for the reaction. For additional details, reference is made to European Patent EP 442 101.

Polyesters that are preferred for use had a solid consistency and can easily be ground into powders or compacted and/or agglomerated to form granules of a defined particle size. The granulation may take place in such a way that the copolymers obtained by synthesis as a melt are solidified to form flakes by cooling in a cool gas stream, for example, a stream of air or nitrogen or by application to a flaking roller or to a running belt. This coarse material may optionally be milled further, for example, in a roll mill or in a screen mill which may be connected to a screening and a rounding as described above. The granulation may also take place in such a way that the polyesters are milled to powder after solidification and are then reacted by compacting and/or agglomeration and the rounding described above to form granules with defined particle sizes.

In a preferred embodiment as contemplated herein, the composition as contemplated herein additionally contains at least one enzyme. In principle all enzymes established in the state of the art for treatment of textiles can be used. There are preferably one or more enzymes that can manifest a catalytic activity in a washing agent in particular a protease, amylase, lipase, cellulase, hemicellulase, mannanase, pectin-cleaving enzyme, tannases, xylanase, xanthanase, β-glucosidase, carrageenase, perhydrolase, oxidase, oxidoreductase as well as mixtures thereof. Preferred suitable hydrolytic enzymes include in particular proteases, amylases in particular α-amylases, cellulases, lipases, hemicellulases in particular pectinases, mannanases, β-glucanases as well as mixtures thereof. Especially preferred are proteases, amylases and/or lipases as well as mixtures thereof and most especially preferred are proteases. These enzymes are in principle of natural origin. Starting from the natural molecules, improved variants which can preferably be used accordingly are available for use in washing agents or cleaning agents.

Under the proteases, those of the subtilisin type are preferred. Examples of these include the subtilisins BPN′ and Carlsberg, the protease PB92, the subtilisins 147 and 309, the alkaline protease from Bacillus lentus, subtilisin DY and the subtilases, but not the enzymes thermitase, proteinase K and the proteases TW3 and TW7 which are to be assigned to the subtilisins in the narrower sense. Subtilisin Carlsberg is available in a further developed form under the brand names Alcalase® from the company Novozymes A/S, Bagsvaerd, Denmark. Subtilisins 147 and 309 are distributed by the company Novozymes under the brand names Esperase® and/or Savinase®. The protease variants carried under the brand name BLAP® are derived from the protease from Bacillus lentus DSM 5483. Additional usable proteases include, for example, those available under the brand names Durazym®, Relase®, Everlase®, Nafizym®, Kannase® and Ovozyme® from the company Novozymes, those available under the brand names Purafect®, Purafect® OxP, Purafect® Prime, Excellase® and Properase® from the company Genencor, the enzyme available under the brand name Protosol® from the company Advanced Biochemicals Ltd. of Thane, India, the enzyme available under the brand name Wuxi® from the company Wuxi Snyder Bioproducts Ltd., China, the enzymes available under the brand names Proleather® and Protease P® from the company Amano Pharmaceuticals Ltd., Nagoya, Japan and the enzyme available under the brand name Proteinase K-16 from the company Kao Corp., Tokyo, Japan. The proteases from Bacillus gibsonii and Bacillus pumilus are also especially preferred for use here.

Examples of amylases that may be used as contemplated herein include the α-amylases from Bacillus licheniformis, from B. amyloliquefaciens or from B. stearothermophilus as well as their improved further refinements for use in washing agents or cleaning agents. The enzyme from B. licheniformis is available from the company Novozymes under the name Termamyl® and from the company Genencor under the name Purastar® ST. Further developed products of these α-amylases are available under the brand names Duramyl® and Termamyl® Ultra from the company Novozymes, under the name Purastar® OxAm from the company Genencor and as Keistase® from the company Daiwa Seiko, Inc., Tokyo, Japan. The α-amylase from B. amyloliquefaciens is distributed under the name BAN® by the company Novozymes, and derived variants of α-amylase from B. stearothermophilus are distributed under the names BSG® and Novamyl®, also by the company Novozymes. In addition, the α-amylase from Bacillus sp. A 7-7 (DSM 12368) and the cyclodextrin glucanotransferase (CGTase) from B. agaradherens (DSM 9948) should be emphasized for this purpose. Likewise, fusion products of all the aforementioned molecules can be used. In addition, the further developments of α-amylase from Aspergillus niger and A. oryzae, which are available under the brand name Fungamyl® from the company Novozymes, are also suitable. Other commercial products that can also be used to advantage include, for example, amylase-LT® and Stainzyme® or Stainzyme Ultra® or Stainzyme Plus®, the latter also available from Novozymes. Variants of these enzymes available by point mutations may also be used as contemplated herein.

Examples of lipases or cutinases that may be used as contemplated herein and are present in particular because of their triglyceride-cleaving activities but also in order to create peracids in situ from suitable precursors include the lipases that are obtainable and/or have been further developed from Humicola lanuginose (Thermomyces lanuginosus), in particular those with the amino acid exchange D96L. They are distributed under the brand names Lipolase®, Lipolase® Ultra, LipoPrime®, Lipozyme® and Lipex®, for example, by the company Novozymes. In addition, for example, the cutinases that were originally isolated from Fusarium solanii and Humicola insolens can also be used. Suitable lipases also include those that can be obtained from the company Amano under the brand names Lipase CE®, Lipase P®, Lipase B® and/or Lipase CES®, Lipase AKG®, Bacillus sp. Lipase®, Lipase AP®, Lipase M-AP® and Lipase AML®. For example, the lipases and/or cutinases, whose starting enzymes were originally isolated from Pseudomonas mendocina and Fusarium solanii by the company Genencor, can also be used. The preparations M1 Lipase® and Lipoma distributed by the company Gist-Brocades and the enzymes distributed under the names Lipase MY-30®, Lipase OF® and Lipase PL® by the company Meito Sangyo KK, Japan should also be mentioned as well as the product Lumafast® from the company Genencor.

Cellulases may be present as pure enzymes, as enzyme preparations or in the form of mixtures, depending on the purpose, in which the individual components advantageously supplement one another with regard to their various performance aspects. These performance aspects include in particular the contributions of cellulase to the primary washing performance of the agent (cleaning performance), regarding the secondary washing performance of the agent (antiredeposition effect or graying inhibition) for the finish (fabric effect) or to have a “stonewashed” effect. A usable fungal cellulase preparation with a high endoglucanase (EG) content and/or further developments thereof is offered by the company Novozymes under the brand name Celluzyme®. The products Endolase® and Carezyme®, which can also be obtained from the company Novozymes, are based on the 50 kD EG and/or the 43 kD EG from H. insolens DSM 1800. Additional commercial products from this company that can also be used include Cellusoft®, Renozyme® and Cellulclean®. In addition, for example, the 20 kD EG from Melanocarpus available from the company AB Enzymes in Finland under the brand names Ecostone® and Biotouch® can also be used. Additional commercial products from the company AB Enzymes include Econase® and Ecopulp®. Other suitable cellulases are CBS 670.93 and CBA 669.93 from Bacillus sp., where the CBS 670.93 from Bacillus sp. is available from the company Genencor under the brand name Puradax®. Additional commercial products from the company Genencor include “Genencor detergent cellulase L” and IndiAge® Neutra. Variants of these enzymes obtainable by point mutations can also be used as contemplated herein. Especially preferred cellulases include Thielavia terrestris cellulase variants, cellulases from Melanocarpus, in particular Melanocarpus albomyces, cellulases from EGIII type from Trichoderma reesei or variants obtainable therefrom.

Furthermore, additional enzymes that can be summarized under the heading hemicellulases can also be used to remove certain problem stains. These include, for example, mannanases, xanthanlyases, xanthanases, xyloglucanases, xylanases, pullulanases, pectin-cleaving enzymes and β-glucanases. The β-glucanase obtained from Bacillus subtilis is available under the brand name Cereflo® from the company Novozymes. Especially preferred hemicellulases as contemplated herein include mannanases which are distributed, for example, under the brand names Mannaway® by the Novozymes company or Purabrite® by the Genencor company. The pectin-cleaving enzymes are also included as enzymes within the scope as contemplated herein under the names pectinase, pectate lyase, pectin esterase, pectin demethoxylase, pectin methoxylase, pectin methyl esterase, pectase, pectin methyl esterase, pectinoesterase, pectin pectyl hydrolase, pectin depolymerase, endopolygalacturonase, pectolase, pectin hydrolase, pectin polygalacturonase, endopolygalacturonase, poly-α-1,4-galacturonide, glycanohydrolase, endogalacturonase, endo-D-galacturonase, galacturan 1,4-α-galacturonidase, exopolygalacturonase, poly(galacturonate) hydrolase, exo-D-galacturonase, exo-D-galacturonase, exopoly-D-galacturonase, exopoly-α-galacturonosidase, exopolygalacturonosidase or exopolygalacturanosidase. Examples of suitable enzyme sin this regard are available under the brand names Gamanase®, Pektinex AR®, X-Pect® or Pectaway® from the Novozymes company, under the brand names Rohapect UF®, Rohapect TPL®, Rohapect PTE100®, Rohapect MPE®, Rohapect MA plus HC, Rohapect DA12L®, Rohapect 10L®, Rohapect B1 L® from AB Enzymes and under the brand name Pyrolase® from Diversa Corp., San Diego, Calif., USA.

Of all these enzymes, those that are comparatively stable with respect to oxidation or have been stabilized by point mutagenesis, for example, are especially preferred. These include in particular the commercial products Everlase® and Purafect® OxP already mentioned above as examples of such proteases and Duramyl® as an example of such an α-amylase.

The compositions as contemplated herein contain enzymes preferably in total amounts of from about 1×10⁻⁸ to about 5% by weight, based on active protein. The enzymes are preferably present in these agents in a total amount of from about 0.001% to about 2% by weight, more preferably from about 0.01% to about 1.5% by weight, even more preferably from about 0.05% to about 1.25% by weight and especially preferably from about 0.01% to about 0.5% by weight, each based on active protein.

In addition, organic surfactants, organic builders, organic chelating agents, organic optical brighteners, organic pH control agents, perfume, organic coloring agents, organic dye transfer inhibitors or mixtures thereof may also be present as additional ingredients in the composition as contemplated herein.

All surfactants known for treatment of textiles can be used as suitable surfactants. However, the composition as contemplated herein should preferably be used as an additive within the scope of a textile washing. For this reason, the composition as contemplated herein necessarily contains from 0% to about 5% by weight surfactant (i.e., from no surfactant up to max. 5% by weight surfactant), preferably from 0% to about 4% by weight, especially preferably from 0% to about 3.5% by weight surfactant.

If the composition as contemplated herein should additionally contain a surfactant, then it is preferable to use soap as the surfactant. Soaps are water-soluble sodium or potassium salts of saturated and unsaturated fatty acids with 10 to 20 carbon atoms, Of the resinic acids of colophony (yellow resin soaps) and of naphthenic acids, which are used as solid or semisolid mixtures mainly for washing and cleaning purposes. Sodium or potassium salts of saturated and unsaturated fatty acid with 10 to 20 carbon atoms, in particular with 12 to 18 carbon atoms, are preferred soaps as contemplated herein. Especially preferred compositions as contemplated herein are characterized in that they contain—based on their weight—from about 0.1% to about 5.0% by weight especially preferably from about 0.5% to about 4.5% by weight most especially preferably from about 1.0% to about 3.0% by weight soap(s).

Organic builders, which may be present in the composition as contemplated herein, are, for example, the polycarboxylic acids that can be used in the form of their sodium salts, wherein polycarboxylic acids are understood to be those carboxylic acids which have more than one acid function. For example, these include citric acid, adipic acid, succinic acid, glutaric acid, malic acid, tartaric acid, maleic acid, fumaric acid, sugar acids, aminocarboxylic acids as well as mixtures of these. Preferred salts include the salts of polycarboxylic acids, such as citric acid, adipic acid, succinic acid, glutaric acid, tartaric acid, sugar acids and mixtures of these.

Suitable builders also include polymeric polycarboxylates, which are, for example, the alkali metal salts of polyacrylic acid or polymethacrylic acid, for example, those with a relative molecular weight of from about 600 to about 750,000 g/mol.

Suitable polymers include in particular polyacrylates which preferably have a molecular weight of from about 1000 to about 15,000 g/mol. Because of their superior solubility, the short-chain polyacrylates having molecular weights of from about 1000 to about 10,000 g/mol and especially preferably from about 1000 to about 5000 g/mol are in turn preferred from this group.

Also suitable are copolymeric polycarboxylates, in particular those of acrylic acid with methacrylic acid and acrylic acid or methacrylic acid with maleic acid. To improve the water solubility, the polymers may also contain alkylsulfonic acids such as allyloxybenzene sulfonic acid and methallyl sulfonic acid as monomers.

An organic optical brightener is preferably selected from the substance classes of distyrylbiphenyls, stilbenes, 4,4′-diamino-2,2′-stilbenedisulfonic acids, coumarins, dihydroquinolinones, 1,3-diarylpyrazolines, naphthalic acid imides, the benzoxazole systems, the benzisoxazole systems, the benzimidazole systems, the pyrene derivatives substituted by heterocycles and mixtures thereof.

Especially preferred organic optical brighteners include disodium-4,4′-bis-(2-morpholino-4-anilino-s-trizin-6-ylamino)stilbenedisulfonate (obtainable, for example, as Tinopal® DMS from BASF SE), disodium-2,2′-bis-(phenylstyryl)disulfonate (obtainable, for example, as Tinopal® CBS from BASF SE), 4,4′-bis[(4-anilino-6-[bis(2-hydroxyethyl)amino]-1,3,5-triazin-2-yl)amino]stilbene-2,2′-disulfonic acid (obtainable, for example, as Tinopal® UNPA from BASF SE), hexasodium-2,2′-[vinylene-bis[(3-sulfonato-4,1-phenylene)imino[6-(diethylamino)-1,3,5-triazine-4,2-diyl]imino]]bis-(benzene-1,4-disulfonate) (obtainable, for example, as Tinopal® SFP from BASF SE), 2,2′-(2,5-thiophendiyl)bis[5-1,1-dimethylethyl]enzoxazole (obtainable, for example, as Tinopal® SFP from BASF SE) and/or 2,5-bis(benzoxazol-2-yl)thiophene.

It is preferable for the organic dye transfer inhibitor to be a polymer or copolymer of cyclic amines such as, for example, vinylpyrrolidone and/or vinylimidazole. Polymers suitable for use as dye transfer inhibitors include polyvinylpyrrolidone (PVP), polyvinylimidazole (PVI), copolymers of vinylpyrrolidone and vinylimidazole (PVP/PVI), polyvinylpyridine N-oxide, poly-N-carboxymethyl-4-vinylpyridium chloride, polyethylene glycol-modified copolymers of vinylpyrrolidone and vinylimidazole as well as mixtures thereof. Especially preferred are polyvinylpyrrolidone (PVP), polyvinylimidazole (PVI) or copolymers of vinylpyrrolidone and vinylimidazole (PVP/PVI) as dye transfer inhibitors. The vinylpyrrolidones (PVP) that are used preferably have an average molecular weight of from about 2500 to about 400,000 and are available commercially from ISP Chemicals as PVP K 15, PVP K 30, PVP K 60 or PVP K 90 or from BASF as Sokalan® HP 50 or Sokalan® HP 53. The copolymers of vinylpyrrolidone and vinylimidazole (PVP/PVI) that are used preferably have a molecular weight in the range of from about 5000 to about 100,000. A PVP/PVI copolymer is available commercially from BASF under the brand name Sokalan® HP 56. Another highly preferred dye transfer inhibitor that can be used include polyethylene glycol-modified copolymers of vinylpyrrolidone and vinylimidazole which are obtainable from BASF under the brand name Sokalan® HP 66, for example.

The composition as contemplated herein of the first subject matter as contemplated herein may additionally contain hydrogen carbonate calculated as sodium hydrogen carbonate for thermal stabilization. Hydrogen carbonate is to be understood as contemplated herein as a chemical compound containing at least one hydrogen carbonate ion (HCO₃⁻) prior to synthesis of the composition as contemplated herein and to be different from the peroxide compounds as contemplated herein. The amount by weight of hydrogen carbonate in the composition as contemplated herein is expressed as the equivalent amount by weight of sodium hydrogen carbonate by definition.

Compositions preferably contain hydrogen carbonate in a total amount of from about 5% to about 50% by weight, especially preferably from about 7.5% to about 30% by weight, calculated as sodium hydrogen carbonate, based on the total weight of the composition.

It is also preferred as contemplated herein to selected hydrogen carbonate from sodium hydrogen carbonate, potassium hydrogen carbonate or mixtures thereof. Sodium hydrogen carbonate is most especially preferred as the hydrogen carbonate.

It has also been found to be preferred for the hydrogen carbonate to be present in a particulate form, in particular as a powder or granules.

It is also preferred if the particles containing hydrogen carbonate (for example, the powder or granules) have a bulk density of from about 0.40 to about 1.50 kg/dm³, especially preferably a bulk density of from about 0.90 to about 1.10 kg/dm³ (each measured according to ISO 697). Within the range of this preferred bulk density, it has proven advantageous and especially preferred if the particles containing the peroxide compound (for example, the powder or granules) have a bulk density of from about 0.70 to about 1.30 kg/dm³, especially preferably a bulk density of from about 0.85 to about 1.20 kg/dm³ (each measured according to ISO 697).

The solid composition as contemplated herein is produced by mixing the raw materials. A batch process or a continuous mixing process may be used here. It is preferred as contemplated herein to use such mixing processes in which the particles of the ingredient (for example, of the powder or of the granules) are not destroyed mechanically. Suitable mixing equipment for this purpose includes in particular tumble mixers, paddle mixers (Forberg, Lödige, Gericke companies) or helix mixers (Amixon, Gebrüder Ruberg companies). The ingredients of the solid composition as contemplated herein are mixed with a low energy input, using in particular mixing tools that mix at a circumferential speed of 0.1 to 5 m/s.

The solid composition of the first subject matter is excellently suited for finishing in a water-soluble portion. The solid composition as contemplated herein of the first subject matter as contemplated herein is present in said portion in a chamber formed by a water-soluble material. The water-soluble material forms walls in the chamber and thereby encloses the composition as contemplated herein of the first subject matter as contemplated herein.

A second subject matter as contemplated herein is therefore a portion for use in treatment of textiles comprising at least one chamber having walls of water-soluble material, wherein a composition of the first subject matter as contemplated herein is contained in this at least one chamber.

A portion is an independent dosing unit with at least one chamber, which contains the substance to be dosed. A chamber is a space bordered by walls (for example, by a film), which can exist even without the substance to be dosed (optionally with a change in its form). A layer of a surface coating explicitly does not fall under the definition of a wall.

The walls of the chamber are made of a water-soluble material. The water solubility of the material can be determined according to the following measurement protocol with the help of a square film of said material (film 22×22 mm with a thickness of 76 μm) affixed in a square frame (edge length on the inside: 20 mm). Said framed film is then immersed in 800 mL distilled water heated to 20° C. in a 1 liter glass beaker having a circular bottom surface (Schott, Mainz, 1000 mL glass beaker, low form), so that the area of the film clamped is arranged at a wide angle to the bottom surface of the glass beaker while the top edge of the frame is 1 cm beneath the surface of the water and the bottom edge of the frame is oriented parallel to the bottom surface of the glass beaker such that the bottom edge of the frame runs along the radius of the bottom surface of the glass beaker and the center of the bottom edge of the frame is disposed above the center of the radius of the bottom of the glass beaker. The material should dissolve within 600 seconds while stirring (stirring speed of the magnetic stirrer 300 rpm, stirring rod 6.8 cm long, diameter 10 mm), so that no single solid film particles are visible to the naked eye. The walls are preferably made of a water-soluble film. As contemplated herein this film may preferably have a thickness of max. about 150 μm (especially preferably of max. about 120 μm). Preferred walls are thus made of a water-soluble film and have a thickness of max. about 150 μm (especially preferably of max. about 120 μm, most especially preferably of max. about 90 μm).

The portion preferably contains the composition of the first subject matter as contemplated herein in a total amount of from about 4.0 to about 10.0 g, in particular of from about 5.0 to about 9.0 g.

If the composition of the first object as contemplated herein is used as an additive to a washing agent, in particular a liquid washing agent, then it is preferable as contemplated herein if the composition of the first object as contemplated herein is supplied in a portion for use in the treatment of textiles comprising at least two chambers with walls made of a water-soluble material, characterized in that
a) at least one of these chambers contains a liquid composition comprising at least one surfactant and
b) at least one additional one of these chambers contains a solid composition of the first object as contemplated herein.

Anionic surfactants, cationic surfactants, amphoteric surfactants and nonionic surfactants may be used as the surfactant of the liquid composition. It is preferable as contemplated herein if the liquid composition of the portion contains at least one anionic surfactant and at least one nonionic surfactant.

Sulfonates and/or sulfates may preferably be used as the anionic surfactant. The anionic surfactant content is from about 5% to about 25% by weight and preferably from about 8 to about 20% by weight, each based on the total first or second liquid washing agent or cleaning agent with a low water content.

Preferred surfactants of the sulfonate type include C₉₋₁₃ alkylbenzene sulfonates, olefin sulfonates, i.e., mixtures of alkene and hydroxyalkane sulfonates as well as disulfonates such as those obtained, for example, from C₁₂₋₁₈ monoolefins with terminal or internal double bonds by sulfonation with gaseous sulfur trioxide and subsequent alkaline or acidic hydrolysis of the sulfonation products. Also suitable are C₁₂₋₁₈ alkanesulfonates and the esters of α-sulfofatty acids (ester sulfonates), for example, the α-sulfonated methyl esters of hydrogenated coconut fatty acids, palm kernel fatty acids or tallow fatty acids.

The alkali salts and in particular the sodium salts of the sulfuric acid hemiesters of the C₁₂-C₁₈ fatty alcohols, for example, those from coconut fatty alcohol, tallow fatty alcohol, lauryl, myristyl, cetyl or stearyl alcohol or C₁₀-C₂₀ oxo alcohols and the hemiesters of secondary alcohols of these chain lengths are preferred as the alk(en)yl sulfates. Of technical interest and washing are the C₁₂-C₁₆ alkyl sulfates and the C₁₂-C₁₅ alkyl sulfate as well as the C₁₄-C₁₅ alkyl sulfates are preferred. Also 2,3-alkyl sulfates are suitable anionic surfactants.

Fatty alcohol ether sulfates such as the sulfuric acid monoesters of linear or branched C₇₋₂₁ alcohols ethoxylated with 1 to 6 mol ethylene oxide are suitable such as 2-methyl-branched C₉₋₁₁ alcohols with an average of 3.5 mol ethylene oxide (EO) or C₁₂₋₁₈ fatty alcohols with 1 to 4 EO.

Other suitable anionic surfactants include soaps. Suitable examples include saturated and unsaturated fatty acid soaps, such as the salts of lauric acid, myristic acid, palmitic acid, stearic acid, (hydrogenated) erucic acid and behenic acid as well as in particular salt mixtures derived from natural fatty acids, for example, coconut, palm kernel, olive oil or tallow fatty acids.

The anionic surfactants as well as the soaps may be present in the form of their sodium, potassium or magnesium or ammonium salts. The anionic surfactants are preferably present in the form of their ammonium salts. Preferred counterions for the anionic surfactants are the protonated forms of choline, triethylamine, monoethanolamine or methyl ethyl amine.

In a most especially preferred embodiment, the liquid composition contains an alkylbenzene sulfonic acid neutralized with monoethanolamine, in particular C₉₋₁₃ alkylbenzene sulfonic acid and/or a fatty acid neutralized with monoethanolamine.

Suitable nonionic surfactants include alkoxylated fatty alcohols, alkoxylated fatty acid alkyl esters, fatty acid amides, alkoxylated fatty acid amides, polyhydroxy fatty acid amides, alkyl phenol polyglycol ethers, amine oxides, alkyl polyglucoside and mixtures thereof.

Alkoxylated, advantageously ethoxylated, in particular primary alcohols preferably with 8 to 18 carbon atoms and an average of 4 to 12 mol ethylene oxide (EO) per mol alcohol are preferably used as the nonionic surfactant, in which the alcohol moiety is linear or may preferably be methyl-branched in position 2 and/or may contain linear and methyl-branched moieties in the mixture such as how they are usually present in oxo alcohols radicals. In particular, however, alcohols ethoxylates with linear radicals from alcohols of native origin with 12 to 18 carbon atoms, for example, from coconut, palm and tallow fatty or oleyl alcohol and an average of 5 to 8 EO per mol alcohol are preferred in particular. The preferred ethoxylated alcohols include, for example, C₁₂₋₁₄ alcohols with 4 EO or 7 EO, C₉₋₁₁ alcohol with 7 EO, C₁₃₋₁₅ alcohols with 5 EO, 7 EO or 8 EO, C₁₂₋₁₈ alcohols with 5 EO or 7 EO and mixture thereof. The stated degrees of ethoxylation are statistical averages which may be a whole number or a fraction for a specific product. Preferred alcohol ethoxylates have a narrow homolog distribution (narrow range ethoxylates, NRE). In addition to these nonionic surfactants, fatty alcohols with more than 12 EO may also be used. Examples of these include tallow fatty alcohol with 14 EO, 25 EO, 30 EO or 40 EO. Nonionic surfactants containing EO and PO groups together in the molecule can also be used as contemplated herein. Also suitable is a mixture of a (more strongly) branch ethoxylated fatty alcohol and an unbranched ethoxylated fatty alcohol such as, for example, a mixture of a C₁₆₋₁₈ fatty alcohol with 7 EO and 2-propylheptanol with 7 EO. In particular, preferably the liquid composition contains a C₁₂₋₁₈ fatty alcohol with 7 EO, a C₁₃₋₁₅ oxo alcohol with 7 EO and/or a C₁₃₋₁₅ oxo alcohol with 8 EO as a nonionic surfactant.

The nonionic surfactant content is from about 1% to about 25% by weight and preferably from about 2% to about 20% by weight, each based on the total liquid composition.

The total amount of surfactant in the liquid composition is preferably up to about 85% by weight, preferably from about 40 to about 75% by weight and especially preferably from about 50% to about 70% by weight, each based on the total liquid composition.

It is preferable as contemplated herein if the liquid composition additionally contains at least one polyalkoxylated polyamine.

This polyalkoxylated polyamine as contemplated herein and its individual aspects relate to a polymer with a backbone containing an N atom which has polyalkoxy groups on the N atoms. At the ends (terminus and/or side chains) the polyamine has primary amino functions and in the interior it preferably has both secondary and tertiary amino functions. It may optionally have only secondary amino functions in the interior so that the result is a linear polyamine instead of a branched chain polyamine. The ratio of primary to secondary amino groups in the polyamine is preferably in the range of from about 1:0.5 to about 1:1.5, in particular in the range of from about 1:0.7 to about 1:1. The ratio of primary to tertiary amino groups in the polyamine is preferably in the range of from about 1:0.2 to about 1.1, in particular in the range of from about 1:0.5 to about 1:0.8. The polyamine preferably has an average molecular weight in the range of from about 500 g/mol to about 50,000 g/mol, in particular from about 550 g/mol to about 5000 g/mol. The N atoms in the polyamine are separated from one another by alkylene groups, preferably by alkylene groups with 2 to 12 carbon atoms, in particular 2 to 6 carbon atoms, wherein not all alkylene groups must have the same number of carbon atoms. Ethylene groups, 1,2-propylene groups, 1,3-propylene groups and mixture thereof are especially preferred. Polyamines having ethylene groups as said alkylene group are also known as polyethylene imine or PEI. PEI is a polymer with a backbone containing nitrogen atoms that is especially preferred as contemplated herein.

The primary amino functions in the polyamine may contain one or two polyalkoxy groups, and the secondary amino functions may have one polyalkoxy group wherein not all amino functions must have alkoxy group substituents. The average number of alkoxy groups per primary and secondary amino functions in the polyalkoxylated polyamine is preferably from 1 to 100, in particular from 5 to 50. The alkoxy groups in the polyalkoxylated polyamine are preferably polypropoxy groups, which are bound directly to nitrogen atoms and/or polyethoxy groups, which are bound to N atoms and propoxy groups that are optionally present and are bound to N atoms that do not have any propoxy groups.

Polyethoxylated polyamines are obtained by reacting polyamines with ethylene oxide (abbreviated EO). The polyalkoxylated polyamines containing ethoxy groups and propoxy groups are preferably accessible by reaction of polyamines with propylene oxide (abbreviated PO) and subsequent reaction with ethylene oxide.

The average number of propoxy groups per primary and secondary amino function in the polyalkoxylated polyamine is preferably from 1 to 40, in particular from 5 to 20.

The average number of ethoxy groups per primary and secondary amino function in the polyalkoxylated polyamine is preferably from 10 to 60, in particular from 15 to 30.

If desired, the terminal OH function as polyalkoxy substituents in the polyalkoxylated polyamine may be partially or completely etherified with a C₁-C₁₀ in particular C₁-C₃ alkyl group.

As contemplated herein, especially preferred polyalkoxylated polyamines may be selected from polyamine reacted with 45 EO per primary and secondary amino function, PEIs reacted with 43 EO per primary and secondary amino function, PEIs reacted with 15 EO+5 PO per primary and secondary amino function, PEIs reacted with 15 PO+30 EO per primary and secondary amino function, PEIs reacted with 5 PO+39.5 EO per primary and secondary amino function, PEIs reacted with 5 PO+15 EO per primary and secondary amino function, PEIs reacted with 10 PO+35 EO per primary and secondary amino function, PEIs reacted with 15 PO+30 EO per primary and secondary amino function and PEIs reacted with 15 PO+5 EO per primary and secondary amino function. PEI containing from 10 to 20 nitrogen atoms, reacted with 20 units EO per primary or secondary amino function of the polyamine, is a most especially preferred alkoxylated polyamine.

Another preferred subject matter as contemplated herein is the use of polyalkoxylated polyamines obtainable by reaction of polyamines with ethylene oxide and optionally additional propylene oxide. If polyamines polyalkoxylated with ethylene oxide and propylene oxide are used, then the amount of propylene oxide and the total amount of alkylene oxide is preferably from about 2 mol % to about 18 mol %, in particular from about 8 mol % to about 15 mol %.

The liquid composition contains, based on its total weight, polyalkoxylated polyamines, preferably in a total amount of from about 0.5 to about 10% by weight, in particular of from about 1.0 to about 7.5% by weight.

The liquid composition finished in the water-soluble portion in the first chamber may contain water, wherein the amount of water in particular for the liquid compositions, may be at most about 20% by weight, preferably at most about 15% by weight, based on the total liquid composition.

The liquid composition may contain additional ingredients which further improve the technical use properties and/or aesthetic properties of the liquid composition. As contemplated herein, the liquid composition preferably additionally contains one or more substances from the group of builders, enzymes, electrolytes, pH adjusting agents, perfumes, perfume vehicles, fluorescent agents, coloring agents, hydrotropes, foam inhibitors, silicone oils, antiredeposition agents, graying inhibitors, shrinkage preventers, wrinkle-preventing agents, antimicrobial active ingredients, nonaqueous solvents, germicides, fungicides, antioxidants, preservatives, corrosion inhibitors, antistatics, bitter substances, ironing aids, water repellents and impregnation agents, skin care agents, swelling agents and anti-slip agents, softening components as well as UV absorbers.

The portion preferably contains the liquid composition in a total amount of from about 10.0 to about 20.0 g, in particular of from about 14.0 to about 18.0 g.

The portion necessarily includes water-soluble material to form the adjacent wall of the at least one chamber. The water-soluble material is preferably formed by a water-soluble film material.

Such water-soluble portions can be prepared either by methods of vertical mold filling sealing (VFFS) or by thermoforming methods.

The thermoforming method in general includes forming a first layer of a water-soluble film material to form at least one bulge to receive at least one composition therein, filling the composition into the respective bulge, covering the bulges filled with the composition using a second layer of a water-soluble film material and then sealing the first and second layers to one another at least around the bulges.

The water-soluble material preferably contains at least one water-soluble polymer. In addition, the water-soluble material preferably contains a water-soluble film material selected from polymers or polymer mixtures. The wrapping may be formed from one or two or more layers from the water-soluble film material. The water-soluble film material of the first layer and of the additional layers, if present, may be same or different.

It is preferable for the water-soluble material to contain polyvinyl alcohol or a polyvinyl alcohol copolymer.

Suitable water-soluble films as the water-soluble material are preferably based on a polyvinyl alcohol or a polyvinyl alcohol copolymer whose molecular weight is in the range of from about 10,000 to about 1,000,000 g/mol⁻¹, preferably from about 20,000 to about 500,000 g/mol⁻¹, especially preferably from about 30,000 to about 100,000 g/mol⁻¹ and in particular from about 40,000 to about 80,000 g/mol⁻¹.

Polyvinyl alcohol is usually prepared by hydrolysis of polyvinyl acetate because the direct synthesis pathway is impossible. The same thing is also true of polyvinyl alcohol copolymers, which are synthesized from polyvinyl acetate copolymers accordingly. It is preferable if at least one layer of the water-soluble material includes a polyvinyl alcohol, whose degree of hydrolysis constitutes from about 70 to about 100 mol %, preferably from about 80 to about 90 mol %, especially preferably from about 81 to about 89 mol % and in particular from about 82 to about 88 mol %.

In addition, polymers selected from the group comprising acrylic acid-containing polymers, polyacrylamides, oxazoline polymers, polystyrene sulfonates, polyurethanes, polyesters, polyethers of polylactic acid and/or mixtures of the preceding polymers may also be added to film material that is suitable for use as the water-soluble material.

Preferred polyvinyl alcohol copolymers include in addition to vinyl alcohol, dicarboxylic acids as additional monomers. Suitable dicarboxylic acids include itaconic acid, malonic acid, succinic acid and mixtures thereof, but itaconic acid is preferred.

Likewise, preferred polyvinyl alcohol copolymers include, in addition to vinyl alcohol, an ethylenically unsaturated carboxylic acid, its salt or ester. Such polyvinyl alcohol copolymers preferably contain, in addition to vinyl alcohol, in particular acrylic acid, methacrylic acid, acrylic acid esters, methacrylic acid esters or mixtures thereof.

Suitable water-soluble films for use as the water-soluble material of the water-soluble portion as contemplated herein include films that are distributed under the brand name MonoSol M8630 by MonoSol LLC. Other suitable films include films with the brand names Solublon® PT, Solublon® KA, Solublon® KC or Solublon® KL from Aicello Chemical Europe GmbH or the VF-HP films from Kuraray.

The aforementioned preferred embodiments of the first subject matter as contemplated herein are also preferred for the solid composition contained in the water-soluble portion according to the first subject matter as contemplated herein.

The portion preferably contains the solid composition in a total amount of from about 4.0 to about 10.0 g, in particular from about 5.0 to about 9.0 g.

In a third subject matter as contemplated herein, the use of a composition of the first subject matter as contemplated herein for treatment of textiles.

Within the scope of this use it is preferred if the composition is fabricated in a portion of the second subject matter as contemplated herein. Again, the embodiment form of a portion with at least two chambers is preferred, such as that described within the context of the second subject matter as contemplated herein.

A fourth subject matter as contemplated herein is a method for treatment of textiles containing the steps of dosing a composition of the first subject matter as contemplated herein to produce a wash liquor containing water and bringing the resulting wash liquor in contact with textiles.

The preferred embodiments described for the first and second subject matters as contemplated herein are also applicable, mutatis mutandis, for the third and fourth subject matters as contemplated herein.

Another preferred embodiment as contemplated herein is characterized by the following points:

1. Solid composition for use in treatment of textiles, containing the following, each based on the total weight of the solid composition in a total amount of
from about 25% to about 65% by weight of at least one peroxide compound,
from about 10% to about 20% by weight of at least one organic bleach activator,
from about 5% to about 20% by weight of an alkali metal silicate calculated without the water content,
from about 1% to about 15% by weight of at least one polysaccharide,
from 0 to about 2% by weight surfactant.

2. Composition according to point 1, characterized in that, based on the total weight of the composition, peroxide compounds are present in a total amount of from about 30 to about 50% by weight, in particular from about 33 to about 45% by weight.

3. Composition according to any one of points 1 or 2, characterized in that the peroxide compound is selected from sodium percarbonate, sodium perborate, sodium peroxodisulfate or mixtures thereof.

4. Composition according to any one of points 1 to 3, characterized in that the peroxide compound is present as a powder or granules, preferably with a bulk density of from about 0.70 to about 1.30 kg/dm³, especially preferably with a bulk density of from about 0.85 to about 1.20 kg/dm³.

5. Composition according to point 4, characterized in that the peroxide compound has an average grain size (volume average) X_{50.3} of from about 0.40 to about 0.95 mm in particular of from about 0.40 to about 0.90 mm.

6. Composition according to any one of points 1 to 5, characterized in that sodium silicate and/or potassium silicate, in particular sodium silicate is present as the alkali metal silicate.

7. Composition according to any one of points 1 to 6, characterized in that the alkali metal silicates are selected from those with the formula (SiO₂)ₙ(Na₂O)ₘ(K₂O)ₚ, where n stands for a positive rational number and m and p, independently of one another, stand for a positive rational number, with the provisions that at least one of the parameters m or p is different from 0 and the ratio between n and the sum of m and p is between about 1:4 and about 4:1, in particular in the ratio range from about 2:1 to about 4:1.

8. Composition according to any one of points 1 to 7, characterized in that the alkali metal silicates are selected from those of the formula (SiO₂)ₙ(Na₂O)ₘ, where n stands for a positive rational number and m stands for a positive rational number, with the provision that the ratio between n and m is between about 1:4 and about 4:1, in particular in the ratio range of from about 2:1 to about 4:1.

9. Composition according to any one of points 1 to 8, characterized in that the weight ratio of alkali silicate to peroxide compound is in a range from about 1:10 to about 1:4.

10. Composition according to any one of points 1 to 9, characterized in that at least one polysaccharide containing at least one anionic group (preferably at least one polysaccharide containing at least one carboxyl group, most especially preferably carboxymethyl cellulose) is present as the polysaccharide.

11. Composition according to any one of points 1 to 10, characterized in that the polysaccharide that is present jointly in a particle with a salt containing halide ions (in particular sodium chloride).

12. Composition according to any one of points 1 to 11, characterized in that the polysaccharide that is present is obtained by reaction of polysaccharide (in particular cellulose or starch, especially preferably cellulose) with haloalkane carboxylic acid (in particular 2-chloroacetic acid) in the presence of an alkalizing agent (in particular sodium hydroxide solution).

13. Composition according to any one of points 1 to 12, characterized in that the polysaccharide that is present is present in a particle with an average grain size X_{50.3} of from about 200 to about 1600 μm, in particular from about 300 to about 1400 μm, especially preferably from about 400 to about 1200 μm, most especially preferably from about 600 to about 1100 μm.

14. Composition according to any one of points 1 to 13, characterized in that one or more compounds that form aliphatic peroxycarboxylic acids preferably with 1 to 10 carbon atoms (in particular 2 to 4 carbon atoms) are present as the organic bleach activator.

15. Composition according to any one of points 1 to 14, characterized in that the organic bleach activator is present in a total amount of from about 11% to about 18% by weight, in particular from about 12% to about 16% by weight based on the total weight of the composition.

16. Composition according to any one of points 1 to 15, characterized in that it has an alkalinity of pH about 10.0 to about 11.5, in particular a pH about 10.0 to pH about 10.5 (each measured on a 1% by weight solution of the composition in water at 20° C.).

17. Portion for use in treatment of textiles comprising at least two chambers with walls made of a water-soluble material, characterized in that
a) at least one of these chambers contains a liquid composition containing at least one surfactant and
b) at least one additional one of these chambers contains a solid composition according to any one of points 1 to 16.

18. Portion according to point 17, characterized in that at least one anionic surfactant and at least one nonionic surfactant are contained in the liquid composition.

19. Portion according to any one of points 17 or 18, characterized in that, based on the weight of the liquid composition, the liquid composition contains surfactant in a total amount of up to about 85% by weight, preferably from about 40 to about 75% by weight and especially preferably from about 50 to about 70% by weight.

20. Portion according to any one of points 17 to 19, characterized in that the liquid composition contains, based on its total weight, at most about 20% by weight, in particular at most about 15% by weight water.

21. Portion according to any one of points 17 to 20, characterized in that the water-soluble material contains at least one water-soluble polymer.

22. Portion according to any one of points 17 to 21, characterized in that said liquid composition is present in an amount of from about 10.0 to about 20.0 g, in particular of from about 14.0 to about 18.0 g and said solid composition is present in an amount of from about 4.0 to about 10.0 g, in particular of from about 5.0 to about 9.0 g.

23. Use of a composition according to any one of points 1 to 16 for treatment of textiles.

24. Use according to point 22, characterized in that the composition is fabricated according to any one of points 1 to 16 in a portion corresponding to any one of points 17 to 21.

25. Method for treatment of textiles comprising the steps of dosing a composition according to any one of points 1 to 16 for production of a wash liquor containing water and bringing the resulting wash liquor in contact with textiles.

### Examples

1.0 Production of the Test Compositions

The following compositions of Tables 1 and 2 were prepared:

TABLE 1
Solid composition (amounts in % by weight):

| | V1 | V2 | V3 | E1 | E2 | E3 |
|---|---|---|---|---|---|---|
| Sodium percarbonate (granules) | 38.6 | 39.7 | 39.7 | 39.7 | 39.7 | 39.7 |
| TAED | 13.0 | 13.0 | 13.0 | 13.0 | 13.0 | 13.0 |
| Carboxymethyl cellulose | 6.0 | 6.0 | — | 6.0 | 6.0 | 6.0 |
| Sodium hydrogen carbonate | 23.8 | 20.7 | 29.8 | 17.5 | 11.3 | 9.8 |
| Sodium silicate (SiO₂)_{2.5}(Na₂O) | — | 2.5 | — | 5.0 | 10.0 | 11.2 |
| C₁₈ fatty acid soap | 2.6 | 2.6 | 2.6 | 2.6 | 2.6 | 2.6 |
| Enzymes (protease, lipase, amylase, | 10.7 | 10.7 | 10.7 | 10.7 | 10.7 | 10.7 |
| mannanase) in granules of sodium | | | | | | |
| sulfate | | | | | | |
| Sodium sulfate | to 100 | to 100 | to 100 | to 100 | to 100 | to 100 |
| pH (1% solution in water) | 9.9 | 9.9 | 10.0 | 10.0 | 10.1 | 10.2 |

The sodium percarbonate granules were coated homogeneous with 6 g sodium sulfate according to a known method (WO 2008/012181 A1) and placed in a tumble mixer. Instead of this coated sodium percarbonate, 53.3% by weight sodium percarbonate Q35 (containing 88.18% by weight sodium percarbonate, Evonik Co.) were placed in the mixer. The remaining components were placed in the tumble mixer and the compositions were prepared by dry mixing the components for 3 minutes at 10 revolutions per minute.

TABLE 2
Liquid composition:

| | L1 (wt %) |
|---|---|
| C₁₁₋₁₃ alkylbenzene sulfonic acid | 23.0 |
| C₁₃₋₁₅ alkyl alcohol ethoxylated with 8 mol | 24.0 |
| ethylene oxide | |
| Glycerol | 9.0 |
| 2-Aminoethanol | 6.8 |
| Ethoxylated polyethylene imine | 4.0 |
| C₁₂₋₁₈ fatty acid | 7.5 |
| Diethylenetriamine-N,N,N′,N′,N″- | 3.5 |
| penta(methylenephosphonic acid), | |
| heptasodium salt (sodium DTPMP) | |
| 1,2-Propylene glycol | 4.5 |
| Ethanol | 4.0 |
| Soil-release polymer from ethylene | 1.0 |
| terephthalate and polyethylene oxide terephthalate | |
| Perfume, dye | 1.7 |
| Water | to 100 |

In a stirred vessel, the components of the liquid composition were mixed together in order while stirring.

The following portions were prepared:

| | P1 | P2 | P3 | P4 | P5 | P6 |
|---|---|---|---|---|---|---|
| Solid composition | 8.5 g V1 | 8.5 g V2 | 8.5 g V3 | 8.5 g E1 | 8.5 g E2 | 8.5 g E3 |
| Liquid composition | 16.5 g L1 | 16.5 g L1 | 16.5 g L1 | 16.5 g L1 | 16.5 g L1 | 16.5 g L1 |

To this end a film M8613 from the company Monosol (88 μm) was stretched on a form with a double cavity. The stretched film was heated by contacting heating for a period of 2400 ms at 105° C. and then drawn into the cavity by a vacuum. Next a corresponding amount of the solid composition of Table 1 was preweighed and filled into the cavity and then the amount of liquid composition L1 from Table 2 was added to the second cavity by means of a syringe. Then a cover film (M8630, 90 μm) was placed on the cavities to seal them and welded to the first film by applying heat (150° C., 1000 ms). After breaking the vacuum, each portion was removed from a cavity. After that, one wall of the powder chamber of the portion was perforated with a needle. Therefore, excess air escaped from the powder chamber of the portion and the film of the wall relaxed.

### 2.0 Storage Test at 50° C.

The portions were each stored in a sealed screw-top glass at 50° C. and evaluated visually and olfactorily after one week. After storage, the portions P1 and P2 not as contemplated herein had a bad odor and the liquid phase had turned a brownish discoloration.

The portions P4, P5 and P6 as contemplated herein supplied a satisfactory product without discoloration of the liquid phase and without a bad odor after storage.

The portion P3 not as contemplated herein did not contain any carboxymethyl cellulose and also did not have a bad odor or any discoloration of the liquid phase after storage. In comparison with portion P1, this proves that the instability observed with P1 was caused by the presence of the polysaccharide. This instability was eliminated by addition of alkali silicate to the portions P4 to P6 as contemplated herein.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the various embodiments in any way. Rather, the foregoing detailed description will provide those skilled in the art with a convenient road map for implementing an exemplary embodiment as contemplated herein. It being understood that various changes may be made in the function and arrangement of elements described in an exemplary embodiment without departing from the scope of the various embodiments as set forth in the appended claims.

1. A solid composition for use in treatment of textiles, comprising the following, each based on the total weight of the solid composition in a total amount of:
from about 25% to about 65% by weight of at least one peroxide compound,
from about 10% to about 20% by weight of at least one organic bleach activator,
from about 5% to about 20% by weight of an alkali metal silicate calculated without the water content,
from about 1% to about 15% by weight of at least one polysaccharide,
from 0 to about 5% by weight surfactant.

2. The composition according to claim 1, wherein, based on the total weight of the composition, peroxide compounds are present in a total amount of from about 30 to 50% by weight.

3. The composition according to claim 1, wherein the peroxide compound is selected from the group of sodium percarbonate, sodium perborate, sodium peroxodisulfate, or mixtures thereof.

4. The composition according to claim 1, wherein the peroxide compound is present as a powder or granules.

5. The composition according to claim 4, wherein the peroxide compound has an average grain size (volume average) X_{50.3} of from about 0.40 to about 0.95 mm.

6. The composition according to claim 1, wherein sodium silicate and/or potassium silicate is present as the alkali metal silicate.

7. The composition according to claim 1, wherein the alkali metal silicates are selected from those with the formula (SiO₂)ₙ(Na₂O)ₘ(K₂O)ₚ, where n is a positive rational number and m and p, independently of one another, are a positive rational number, with the provisions that at least one of the parameters m or p is different from 0 and the ratio between n and the sum of m and p is between about 1:4 and about 4:1.

8. The composition according to claim 1, wherein the alkali metal silicates are selected from those of the formula (SiO₂)ₙ(Na₂O)ₘ, where n stands for a positive rational number and m stands for a positive rational number with the provision that the ratio between n and m is between 1:4 and 4:1.

9. The composition according to claim 1, wherein at least one polysaccharide including at least one anionic group is present as the polysaccharide.

10. The composition according to claim 1, wherein the polysaccharide is present jointly in a particle with a salt containing halide ions.

11. The composition according to claim 1, wherein the polysaccharide is obtained by reaction of polysaccharide with haloalkane carboxylic acid in the presence of an alkalizing agent.

12. The composition according to claim 1, wherein the polysaccharide is present in a particle with an average grain size X_{50.3} of 200 to 1600 μm.

13. The composition according to claim 1, wherein one or more compounds that form aliphatic peroxycarboxylic acids are present as the organic bleach activator.

14. The composition according to claim 1, wherein the organic bleach activator is present in a total amount of from about 11 to about 18% by weight on the total weight of the composition.

15. The composition according to claim 1, having an alkalinity of pH about 10.0 to about 11.5 (as measured on a 1% by weight solution of the composition in water at 20° C.).

16. A portion for use in treatment of textiles, wherein the portion comprises at least two chambers with walls made of a water-soluble material, and wherein
at least one of the chambers includes a liquid composition including at least one surfactant, and
at least one additional one of the chambers includes a solid composition Comprising, each based on the total weight of the second composition, a total amount of:
from about 25% to about 65% by weight of at least one peroxide compound,
from about 10% to about 20% by weight of at least one organic bleach activator,
from about 5% to about 20% by weight of an alkali metal silicate calculated without the water content,
from about 1% to about 15% by weight of at least one polysaccharide,
from 0 to about 5% by weight surfactant.

17. The composition according to claim 1, wherein:
based on the total weight of the composition, peroxide compounds are present in a total amount of from about 33% to about 45% by weight;
the peroxide compound has a bulk density of from about 0.85 to about 1.20 kg/dm³; and
the peroxide compound has an average grain size (volume average) X_{50.3} of from about 0.50 to about 0.90 mm.

18. The composition according to claim 1, wherein sodium silicate is present as the alkali metal silicate.

19. The composition according to claim 1, wherein carboxymethyl cellulose is present as the polysaccharide.

20. The composition according to claim 1, wherein the polysaccharide is obtained by reaction of cellulose with 2-chloroacetic acid in the presence of sodium hydroxide solution.
